(19) United States
(12) Patent Application Publication
(10) Pub. No.: US 2016/0178278 A1
(43) Pub. Date: Jun. 23, 2016

(54) Food Waste Vacuum-Drying Disposal System

(71) Applicants: Hyun Ji CHANG, Seoul (KR); Tae Sun CHANG, Seoul (KR); Woo Dam CHANG, Seou (KR)

(72) Inventors: Hyun Ji Chang, Seoul (KR); Tae Sun Chang, Seoul (KR); Woo Dam Chang, Seoul (KR)

(21) Appl. No.: 14/910,623

(22) PCT Filed: Aug. 7, 2014
(86) PCT No.: PCT/KR2014/007309

§ 371 Date: Feb. 5, 2016

(30) Foreign Application Priority Data
Aug. 7, 2013 (KR) 10-2013-0093467

(51) Int. Cl. F26B 5/04; F26B 9/08

(52) U.S. Cl. CPC F26B 5/04; F26B 9/082; F26B 2200/04

(57) ABSTRACT

The present invention relates to a food waste vacuum-drying disposal system and, particularly, to a food waste vacuum-drying disposal system, which can be installed in a food waste collection vehicle due to the simple structure thereof and can carry out vacuum-dry disposal of food waste even while moving during food waste collection. The food waste vacuum-drying disposal system of the present invention is a device capable of: sterilizing and drying inputted food waste by heat converted from a light emitted from a heating element inside a vacuum tank; condensing and discharging, as condensed water, evaporated and sublimed gas generated during a drying process; and discharging, in the air, non-condensed gas such that food waste leachate can be disposed at the same time. Therefore, since radiant heat in a vacuum tank is transformed into heat upon contacting the surface of food waste such that drying is carried out quickly, the present invention can remarkably reduce decomposition, odor, contamination caused by a leachate, proliferation of bacteria, and the like, which may occur during a collection, transport, and disposal process, thereby enabling sanitary disposal and recycling.

### TECHNICAL FIELD

The present invention relates to a food waste vacuum drying treatment system and, more particularly, to a food waste vacuum drying treatment system which can vacuum-dry food waste and food waste leachate at the same time to prevent decomposition, foul odor, contamination due to leachate, proliferation of bacteria, etc., and which can be mounted in a transportation vehicle due to its compact structure to carry out the treatment in real time even during collection.

### BACKGROUND ART

In general, it is well known that food waste coming from households, restaurants, etc. is separately collected and then incinerated, buried, or recycled as feed or compost.

That is, food waste coming from various places is collected by a vehicle and gathered in a collection station, in which food waste leachate with reduced environmental pollution is sent to a sewage treatment plant, and waste is crushed, dried, and then incinerated, buried, or recycled as products such as feed, compost, etc.

In this case, the vehicle that collects food waste produces foul odor due to decomposition while moving, and in the collection station where food waste is collected, contamination due to leachate, foul odor due to decomposition, and proliferation of bacteria occur extensively. Therefore, it is particularly necessary to manage the crushing and drying of the collected food waste.

Moreover, due to decomposition of food waste and food waste leachate, the time required from transportation to treatment maximizes the generation of contaminants.

These contaminants are discharged to the outside from all regions to produce new and unknown pathogens, resulting in the spread of diseases.

Accordingly, it is preferred to safely treat the discharged food waste without any time delay.

Therefore, there is a need to develop a system which can dry and crush food waste upon the collection of the food waste while preventing decomposition, foul odor, contamination due to leachate, performing sterilization, and at the same time, treating food waste leachate.

### DISCLOSURE

### Technical Problem

Accordingly, the present invention has been made in an effort to solve the above-described problems associated with prior art, and an object of the present invention is to provide a food waste vacuum drying treatment system which heats and dries food waste by radiant heat emitted from a photo/thermoelectron in a vacuum state, condenses and discharge evaporated gas to enable sanitary treatment and recycling, and can be mounted in a transportation vehicle due to its compact structure to carry out the treatment in real time even during collection.

### Technical Solution

To achieve the above-described object, the present invention provides a food waste vacuum drying treatment system comprising: a vacuum treatment device which, when food waste is introduced, heats and dries the food wastes by heat emitted from a heating element in a vacuum state, discharges the dried food waste, and transfers steam generated during drying; a condensate separator which condenses the steam transferred from the vacuum treatment device and separates into condensed water and non-condensed water; a vacuum pump which is connected to the condensate separator through a vacuum pipe and discharge non-condensable gas discharged from the condensate separator to the air; an automatic drainage device which discharged the condensed water separated by the condensate separator; and a vacuum backflow prevention device which is interposed between the condensate separator and the automatic drainage device to prevent backflow of the condensed water, wherein the system is made small in size and light in weight and thus can be mounted in a food waste transportation vehicle, which makes it possible to collect and dry the food waste at the same time.

### Advantageous Effects

According to the food waste vacuum drying treatment system of the present invention, with the use of vacuum, there is no need to provide additional external thermal insulation. Therefore, the heat emitted from the heating element is not easily lost and is used to maximum efficiency, and there is no substance that inhibits radiant heat transfer, resulting in maximized efficiency. The vacuum-dried food waste is advantageous to the process of separating foreign substances and crushing food waste. Moreover, there are no ongoing decomposition and foul odor after the discharge, and the sterilized food waste does not cause contamination.

Moreover, the system of the present invention can be mounted in a transportation vehicle due to its simple structure, which makes it possible to prevent the generation of foul odor during transportation and treatment, the occurrence of contamination due to leachate, and the spread of bacteria due to decomposition, and the simultaneous treatment of food waste leachate reduces the costs and have significant effects on the environment.

Furthermore, by-products obtained by vacuum-drying the food waste and removing foreign substances have been sterilized and thus can be recycled as feed or compost. Moreover, such by-products can be easily crushed and incinerated due to low water content, which makes it possible to make the most efficient use of heat, thus solving social problems associated with atmospheric pollution and waste disposal. In particular, it is less likely that high temperature is required to forcibly incinerate wet waste or that contaminants are generated.

### DESCRIPTION OF DRAWINGS

FIG. 1 is a diagram showing the configuration of a food waste vacuum drying treatment system according to the present invention;

FIG. 2 is a flowchart illustrating a food waste vacuum drying treatment process of the system of FIG. 1; and

FIG. 3 is a diagram showing the state where the system of FIG. 1 is mounted in a vehicle.

### BEST MODE FOR CARRYING OUT THE INVENTION

In the best mode for carrying out the invention, there is provided a food waste vacuum drying treatment system comprising: a vacuum treatment device which, when food waste is introduced, heats and dries the food wastes by heat emitted from a heating element in a vacuum state, discharges the dried food waste, and transfers steam generated during drying; a condensate separator which condenses the steam transferred from the vacuum treatment device and separates into condensed water and non-condensed water; a vacuum pump which is connected to the condensate separator through a vacuum pipe and discharge non-condensable gas discharged from the condensate separator to the air; an automatic drainage device which discharged the condensed water separated by the condensate separator; and a vacuum backflow prevention device which is interposed between the condensate separator and the automatic drainage device to prevent backflow of the condensed water, wherein the system is made small in size and light in weight and thus can be mounted in a food waste transportation vehicle, which makes it possible to collect and dry the food waste at the same time.

### MODE FOR INVENTION

Hereinafter preferred embodiments of the present invention will be described in detail with reference to the accompanying drawings.

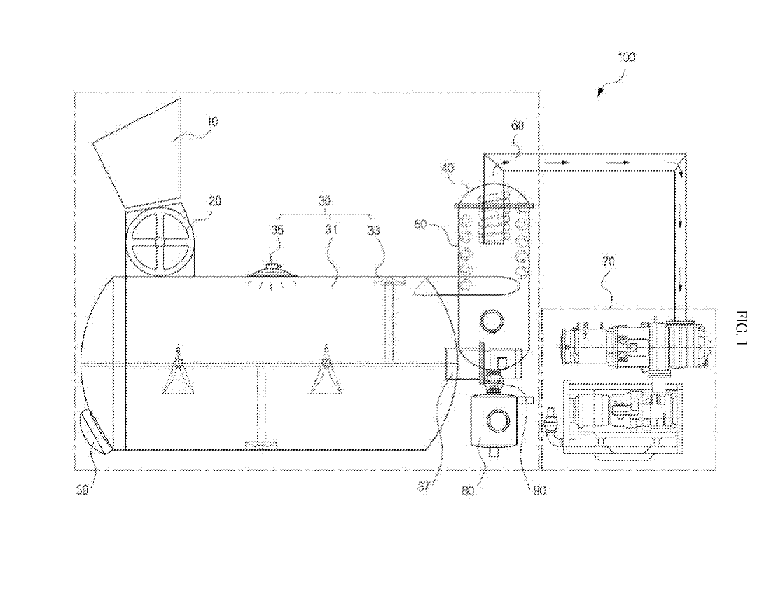

FIG. 1 is a diagram showing the configuration of a food waste vacuum drying treatment system according to the present invention. As shown in FIG. 1, the food waste vacuum drying treatment system 100 of the present invention comprises a hopper 10 which is a guide plate through which food waste is introduced and a rotary feeder 20 which feeds the introduced food waste into a vacuum treatment device 30 when the instruction of food waste through the hopper 10 is detected such that the food waste can be continuously fed.

The vacuum treatment device 30 comprises a vacuum drying tank 31 designed to create a vacuum state, a paddle-type agitator 33 installed in the vacuum drying tank 31 to uniformly spread out the food waste fed through the feeder 20, a heating element 35 for heating and drying the food waste in a vacuum environment, and a rotator 37 for rotating the agitator 33. The vacuum drying tank 31 is connected to a pipe for vacuum exhaust and is provided with a cover 39 for internal cleaning and discharge.

The heating element 35 employs a halogen lamp or ceramic heater for emitting far-infrared waves as a heat source.

Gas coming from the vacuum drying tank 31 is a mixed gas of condensable and non-condensable gases and thus is too bulky to be pumped by a vacuum pump 70. Therefore, a separator 40, which is provided with a condenser for condensing the condensable gas to the maximum to be discharged as condensed water, is installed.

A coolant circulation pipe 50 is provided in the separator 40 to extract condensed water by cooling the condensable gas distilled under vacuum. The condensed water is obtained by condensing the distilled gas in the separator 40 and thus is automatically discharged in a clean state, and the non-condensable gas is discharged to the air through the vacuum pump 70.

A vacuum pipe 60 is provided between the separator 40 and the vacuum pump 70, and an automatic drainage device 80 for discharging condensed water is connected to the bottom of the separator 40.

A vacuum backflow prevention device 90 for preventing backflow of condensed water is interposed between the separator 40 and the automatic drainage device 80.

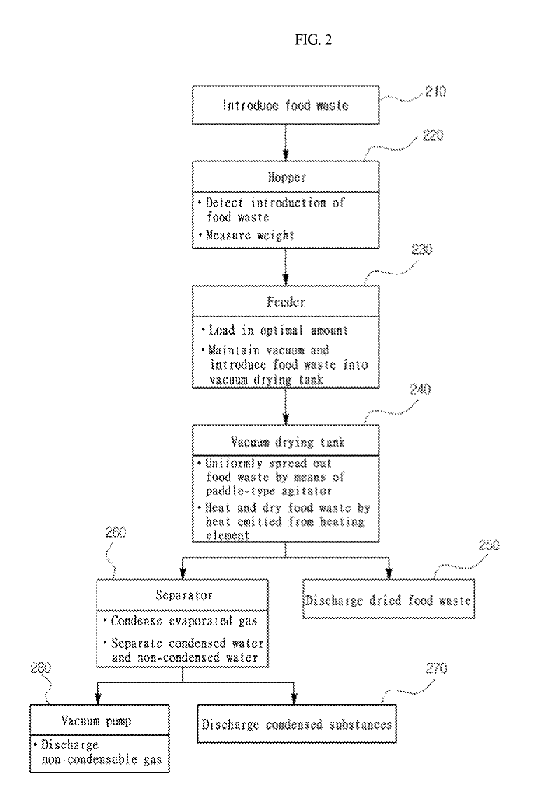

A food waste vacuum drying treatment process of the system of FIG. 1 having the above-described structure will now be described in detail with reference to FIG. 2.

In FIG. 2, food waste bags or collection barrels are collected and food waste is introduced through the hopper 10 (Step 210).

In the hopper 10, the introduction of food waste is detected, and the weight is measured (Step 220).

In the feeder 20, the introduced food waste is loaded fed in an optimal amount to the vacuum treatment device 30 while maintaining the vacuum state (Step 230).

Here, the feeder 20 is a device for feeding the food waste into the vacuum drying tank 31 of the vacuum treatment device 30, and since it is necessary to maintain the vacuum state to the maximum and feed the food waste into the vacuum drying tank 31, the feeder 20 detects and feeds the introduced food waste while rotating. Therefore, a vacuum seal is mounted on a compartment, a fixing unit, and a rotation unit to maintain the vacuum state.

The vacuum drying tank 31 of the vacuum treatment device 30 is made of a structure subjected to external pressure due to atmospheric pressure applied to the outside of the vacuum drying tank 31 and has a structure in which the heating element 35 on the top, such as a photo/thermoelectron, emits far-infrared radiant heat. Here, the vacuum drying tank 31 has a structure in which moisture and volatile substances in the food waste are evaporated and sublimated and then rapidly spread to the maximum, which is supported by the paddle-type agitator 33 installed therein.

Since it is necessary to increase the surface area of the food waste such that the food waste is subjected to heat uniformly and more steam is generated in the vacuum drying tank 31, the paddle-type agitator 33 installed in the vacuum drying tank 31 is rotated by the rotator 37 at a constant speed to uniformly spread out the introduced food waste. The food waste in the vacuum drying tank 31 is dried in a vacuum state by radiant heat emitted from the heating element 35 (Step 240).

In the vacuum environment, there is no heat transfer due to convection, resulting in a thermal insulation effect, and as in the present invention, when far-infrared radiant heat waves of the photo/thermoelectron reach the surface of the food waste, almost all are converted into heat. Therefore, there is no thermal loss and the heat transfer is rapid compared to heating from the outer wall, and thus the food waste is rapidly heated.

At this time, evaporation and sublimation occur in the vacuum environment, the higher the temperature, the higher the evaporation rate in the effusion, and thus rapid movement of steam is made by diffusion.

In the present invention, the food waste is rapidly vacuum-dried by the vacuum condition and radiant heat using this principle.

Evaporated and sublimated gas extracted from the vacuum drying tank 31 is transferred to the separator 40, and the dried food waste is discharged (Step 250).

The coolant circulation pipe 50 is installed in the separator 40 in the vacuum state to extract condensed water, which is heavier than the gas, by cooling the gas transferred from the vacuum drying tank 31, thus separating into condensed water and non-condensed water (Step 260).

Here, the extracted condensed water is a product in an uncontaminated state obtained by condensing the gas, i.e., the steam gas from distillation and is collected at the bottom due to its weight. As a result, the condensed water collected at the bottom is discharged to the outside through the automatic drainage device 80 (Step 270).

Meanwhile, the non-condensable gas, which is not condensed, is discharged to the air through the vacuum pipe 60 (Step 280). Here, the vacuum pump 70 is installed to maintain the vacuum state of the vacuum drying tank 31.

Although there are various types of vacuum pumps 70, a multistage dry pump is used in this embodiment. This pump does not require a fluid for sealing, i.e., liquid of a liquid ring vacuum pump and oil of oil rotary vacuum pump, which does not discharge secondary pollutants and thus is most preferred.

Therefore, according the present invention, it is possible to prevent all problems from occurring during time delay such as during transportation, during treatment standby, and during treatment, and the condensed water evaporated after sterilization is directly discharged, which reduces the weight of the food waste.

Moreover, the food waste subjected to the vacuum drying treatment has less secondary pollutants and no odor, which is advantageous to the process of separating foreign substances and crushing food waste, does not cause atmospheric pollution during incineration, which makes it possible to make the most efficient use of heat, and can be used as feed and compost as clean materials.

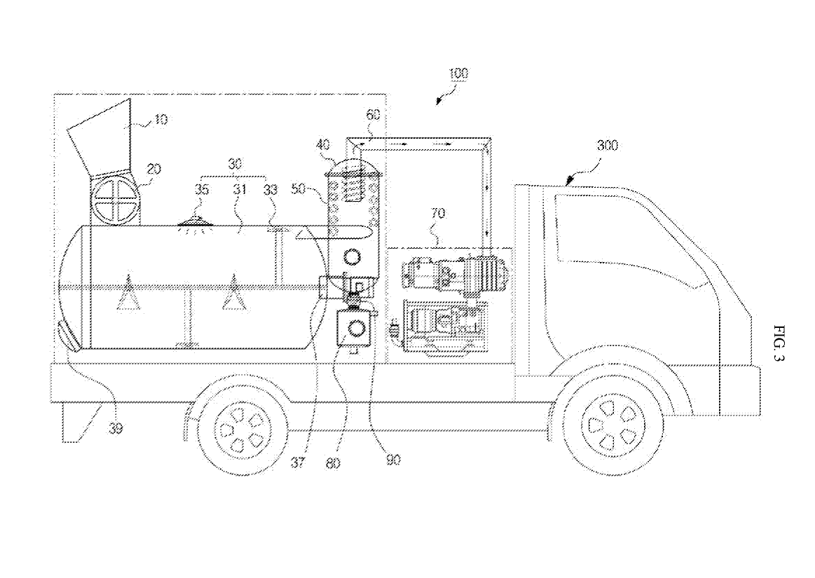

FIG. 3 is a diagram showing the state where the system of FIG. 1 is mounted in a vehicle.

As shown in FIG. 3, the food waste treatment system of the present invention is made small in size and light in weight and thus can be mounted and towed in a vehicle, which makes it possible to immediately treat the introduced food waste, thus preventing various problems from occurring in the collected food waste.

Moreover, since hydraulic equipment is mounted in a food waste transportation vehicle 300, the agitator 33 can be driven using a hydraulic motor mounted in the vehicle 300, and the vacuum pump 70 can be driven by the power of the engine of the vehicle 300.

In addition, with the use of heat in vacuum, the difference in thermal gradient is significantly low, and the heat transfer is rapid. Moreover, the system can be used for a long time and is compact in size, which reduces the required area and provides high efficiency.

### INDUSTRIAL APPLICABILITY

As described above, the food waste treatment system of the present invention can be widely used in the field of treatment and recycling of food waste coming from households, restaurants, etc.

1. A food waste vacuum drying treatment system comprising: a vacuum treatment device which, when food waste is introduced, heats and dries the food wastes by heat emitted from a heating element in a vacuum state, discharges the dried food waste, and transfers steam generated during drying; a condensate separator which condenses the steam transferred from the vacuum treatment device and separates into condensed water and non-condensed water; a vacuum pump which is connected to the condensate separator through a vacuum pipe and discharge non-condensable gas discharged from the condensate separator to the air; an automatic drainage device which discharged the condensed water separated by the condensate separator; and a vacuum backflow prevention device which is interposed between the condensate separator and the automatic drainage device to prevent backflow of the condensed water, wherein the system is made small in size and light in weight and thus can be mounted in a food waste transportation vehicle, which makes it possible to collect and dry the food waste at the same time.

2. The food waste vacuum drying treatment system of claim 1, wherein the vacuum treatment device comprises: a vacuum drying; a heating element which is installed at the top of the inside of the vacuum drying tank to heat and dry the food waste by radiant heat in a vacuum state; a paddle-type agitator which is installed on the inner circumference of the vacuum drying tank to uniformly spread out the food waste fed into the vacuum drying tank; a vacuum rotator for rotating the agitator at a constant speed; and a cover which for internal cleaning of the vacuum drying tank and discharge of the dried food waste.

3. The food waste vacuum drying treatment system of claim 1 or 2, wherein the heating element is a halogen lamp or ceramic heater which emits far-infrared waves.

4. The food waste vacuum drying treatment system of claim 2, wherein the vacuum treatment device comprises an inlet which is connected to a feeder in the form of a compartment such that the vacuum state of the vacuum drying tank is maintained when the food waste is introduced therethrough.

5. The food waste vacuum drying treatment system of claim 2, wherein the condensate separator comprises a coolant circulation pipe which is connect to the vacuum drying tank and is provided in the condensate separator to cool gas evaporated and sublimated in the vacuum drying tank.
